(19) United States
(12) Patent Application Publication
(10) Pub. No.: US 2007/0188304 A1
(43) Pub. Date: Aug. 16, 2007

(54) Method, Content Server and Content Client for Implementing Mobile Data Broadcast Service

(75) Inventor: Shengqiong Wang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/684,835

(22) Filed: Mar. 12, 2007

Related U.S. Application Data
(63) Continuation of application No. PCT/CN06/00267, filed on Feb. 24, 2006.

(30) Foreign Application Priority Data
Feb. 25, 2005 (CN) 200510051042.9

(51) Int. Cl. G08B 5/22

(52) U.S. Cl. 340/7.22

(57) ABSTRACT

A method for implemplenting a mobile data broadcast service includes: determining that a content client does not receive a broadcast message; transferring the broadcast message to the content client after learning that a terminal corresponding to the content client accesses a network. The embodiments of the invention also provide a Content Server(CS) and a content client for implementing a mobile data broadcast service. According to the embodiments of the invention, even if a user does not receive the broadcast message because his/her terminal is off-line, the user may receive the broadcast message customized by him/her after his/her terminal accesses the network, which improves the customer satisfaction, increases the income of operators, and accelerates the development of broadcast services.

### CROSS-REFERENCE TO RELATED APPLICATIONS

This is a continuation of International Application No. PCT CN2006/000267 filed Feb. 24, 2006, which claims the benefit of Chinese Patent Application No. 200510051042.9, filed Feb. 25, 2005, the entire respective disclosures of which are hereby incorporated herein by reference.

### BACKGROUND OF THE INVENTION

1. Field of the Invention

The invention relates to mobile data broadcast techniques, and more particularly, to a method, a Content Server (CS) and a content client for implementing a mobile data broadcast service.

2. Background of the Invention

Broadcast (BCAST) is a mobile wideband digital broadcast/multicast service. It not only supports a traditional point-to-multipoint broadcast manner and a multicast transmission manner, but also combines with conventional digital broadcast services in the existing network architecture. A mobile phone TV service may be the most predominant one among future mobile broadcast services, and it is through the mobile broadcast network to receive information like TV contents. In general, the mobile broadcast services may broadcast a large number of multimedia contents with a lower cost and greater efficiency, thereby improving the media content consumption at mobile equipment. Furthermore, the mobile broadcast services may encourage such consumption demands as a new color display intelligent handset with a broadcast function, storage capacity of a handset, TV contents, and multimedia contents.

A mobile broadcast data communication system is shown in FIG. 1, which includes Content Servers (CSs), Broadcast Distribution Systems (BDSs), and a content client. The CSs provide contents to be broadcasted. Ifhe BDSs broadcast the contents to the content client, and the content client installed on a terminal receives and uses the contents broadcasted. The system also includes: general function modules, for performing such general functions as charging, digital copyright protection, security authentication and so on; interaction access function modules, for transferring contents or signal lings; BDS access function modules, for implementing interface functions for the BDSs, for example, modifying IP based data flows from the general function modules, generating IP based data flows independent from the bottom-layer BDSs for the general function modules, and mapping functions of the general function modules to capabilities of the bottom-layer BDSs; an IP based point-to-point direct interaction channel, for providing IP based signaling interactions or content interactions between the general function modules, which is optional.

In the mobile broadcast data communication system of the conventional art, when broadcasting, a CS transfers a broadcast message to a BDS through a general function module and a BDS access function module. Then, the BDS transfers the broadcast message, through another BDS access function module and another general function module, to the content client. The content client provides the contents of the broadcast message to the terminal upon receiving the broadcast message.

The broadcast message may also be transferred from a general function module on the CS side to a general function module on the content client side through the interaction access function module. Then, the general function module on the content client side transfers the broadcast message to the content client. Additionally, the broadcast message may be directly transferred from a general function module on the CS side to a general function module on the client side through the IP based point-to-point direct interaction channel.

In the conventional art, a user may choose a broadcast service on his/her own initiative by customization. For example, the user may customize broadcast services such as a weather forecast, a mobile phone TV service, and so on. Usually, the user needs to pay extra service fees for these broadcast services.

However, in the conventional art, the CS transfers a broadcast message once. If the terminal is in a power-off state or in an off-line state such as out of service area when the CS transfers the broadcast message, the content client will fail to receive the broadcast message transferred by the CS. Moreover, if the content client fails to receive the broadcast message because the terminal is off-line, the content client can not receive the broadcast message any more even if the terminal accesses the network later, which greatly lowers customer satisfaction, reduces the income of operators, and affects the development of broadcast services.

### SUMMARY OF THE INVENTION

The embodiments of the invention provide a method, a Content Server (CS) and a content client for implementing a mobile data broadcast service.

A method for implementing a mobile data broadcast service includes:
determining that a content client does not receive a broadcast message; and
transferring the broadcast message to the content client after learning that a terminal corresponding to the content client accesses a network.

A Content Server (CS) for implementing a mobile data broadcast service includes:
a first module, for determining that a content client does not receive a broadcast message after sending the broadcast message; and
a second module, for transferring the broadcast message to the content client according to the result of determining when a terminal corresponding to the content client accesses a network.

A content client for implementing a mobile data broadcast service includes:
a first module, for recording a relationship between a receipt-guaranteed broadcast service and the content client;
a second module, for determining whether a broadcast service to which a broadcast message received belongs is the receipt-guaranteed broadcast service according to the relationship;
a third module, for outputting a response message if the second module determines that the broadcast service is the receipt-guaranteed broadcast service.

As can be seen from the above technical scheme, in embodiments of the invention, after transferring a broadcast message, the CS determines whether the content client receives the broadcast message. If the content client does not receive the broadcast message, the CS transfers the broadcast message to the content client after the terminal corresponding to the content client accesses the network. Thus, even if the broadcast message can not be received because the terminal is off-line, the user may receive the broadcast message customized by him/her after the terminal accesses the network. By doing so, the customer satisfaction is improved, the income of operators is increased, and the development of broadcast services is accelerated.

In the embodiments of the invention, the receipt-guaranteed broadcast service customized by the user is set in the content client. Upon receiving the broadcast message transferred by the CS, the content client, according to the receipt-guaranteed broadcast service set in the content client, determines whether to return a response message, which prevents the content client from returning a response message for broadcast services without a receipt-guaranteed function customized, thereby avoiding unnecessary network information transmission and lightening the burden of networks.

### BRIEF DESCRIPTION OF THE DRAWINGS

FIG. 1 is a simplified schematic diagram illustrating a conventional mobile broadcast data communication system.

FIG. 2 is a simplified flow chart illustrating a method for implementing a mobile data broadcast service in accordance with embodiments of the invention.

FIG. 3 is a simplified flow chart illustrating the processing procedure of a Content Server in accordance with an embodiment of the invention.

FIG. 4 is a simplified flow chart illustrating the processing procedure of a content client in accordance with another embodiment of the invention.

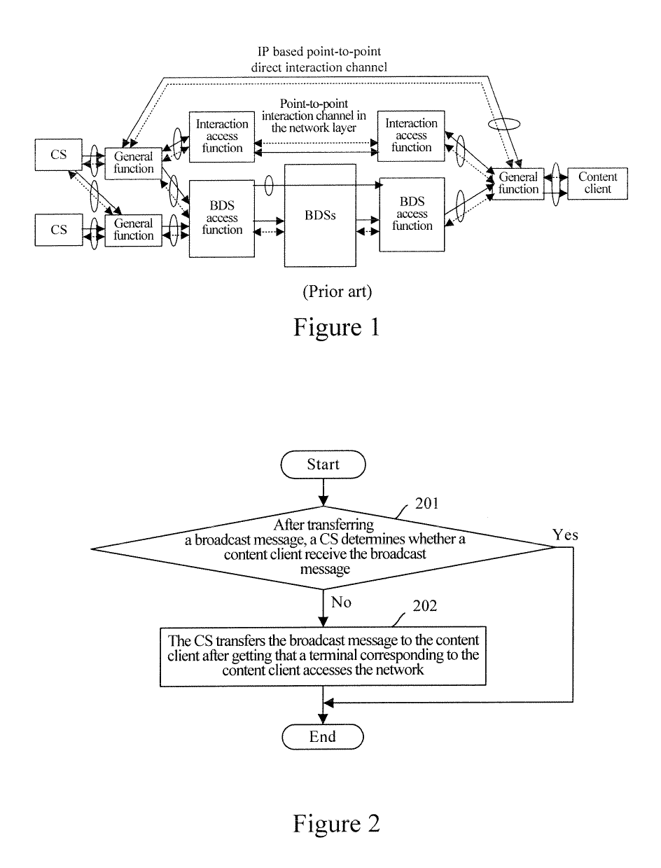

### DETAILED DESCRIPTION OF THE PREFERRED EMBODIMENTS

The embodiments of the invention are hereinafter described in detail with reference to the accompanying drawings to further clarify the technical scheme and advantages of the invention.

A CS determining whether a content client receives a broadcast message after transferring the broadcast message; if the content client does not receive the broadcast message, the CS transfers the broadcast message to the content client after a terminal corresponding to the content client accesses the network. A general flow chart illustrating a method for implementing a mobile data broadcast service is as shown in FIG. 2, and includes the following processes.

Process 201: after transferring a broadcast message, a CS determines whether a content client receives the broadcast message. If the content client receives the broadcast message, terminate the procedure directly; otherwise, perform Process 202.

Process 202: the CS transfers the broadcast message to the content client after a terminal corresponding to the content client accesses the network.

In an embodiment of the invention, the process of the terminal accessing the network includes: the terminal where the content client is located accessing the network by switching from a power-off state to a power-on state and the terminal entering a service area from a non-service area.

Since the broadcast message is transferred to multiple content clients, the CS should determine whether all content clients receive the broadcast message in Process 201. Through the determining, the CS may get that some content clients receive the broadcast message while others do not receive the broadcast message. For those content clients not receiving the broadcast message, the CS assures them of receiving the broadcast message by performing Process 202 that is, transferring the broadcast message once again to the content clients not receiving the broadcast message.

Merely by way of an example, the process of determining whether the content client receives the broadcast message may be implemented by returning a response message by the content client to the CS after the content client receives the broadcast message. Since the broadcast message is usually transferred to multiple content clients, multiple response messages may be returned from the content clients to the CS. Through these response messages, the CS may determine which content clients receive the broadcast message and which ones do not receive the broadcast message.

A detailed description of the invention is provided hereinafter with reference to the specific embodiments and accompanying drawings.

In an embodiment of the invention, a corresponding relationship between a broadcast service identity and a content client identity is set beforehand in a database of the CS, as shown in Table 1. The content client identity includes all identities of the broadcast service receipt-guaranteed content clients corresponding to the broadcast service identity. Merely by way of an example, the content client identity may be an identity of a terminal where the content client is located. The broadcast service receipt-guaranteed content clients may be the ones corresponding to all users customizing a certain broadcast service or the ones determined by user customization. For example, the content clients of users customizing a certain broadcast service include A, B, C, D and E, and users corresponding to A and C make a customization to receive the broadcast service assumingly, then the broadcast service receipt-guaranteed content clients include only A and C.

In an example, the user may implement customization by transferring a customization message to the CS through the content client. The customization message includes information of a broadcast service customized by the user, a content client identity and information denoting that the broadcast service receipt-guaranteed broadcast message. In another example, the user may implement the customization through a telecom business office or a network. In the former customization manner, the CS adds a content client identity in the customization message to an item corresponding to the content client identity in Table 1 according to information of the broadcast service in the customization message upon receiving the customization message transferred by the content client.

TABLE 1

| Broadcast | Broadcast | Content |
|---|---|---|
| service name | service identity | client identity |
| Weather forecast | 00012 | A, B, C, D |
| Mobile phone TV | 00013 | E, F, G, H . . . |
| . . . | . . . | . . . |

In the present embodiment, it is necessary to set in the CS a reception period of time for the CS receiving a response message returned by the content client. The reception period of time may be determined according to specific network situations, for example, in the case of a short network delay, the reception period of time may be set as one minute or several minutes; instead, in the case of a long network delay, the reception period of time may be set as one hour or several hours.

During the implementation of a broadcast service, the content client returns a response message to the CS upon receiving, a broadcast message transferred by the CS. Merely by way of an example, the response message may include a broadcast message identity, a content client identity, etc. The response message may be transferred through a point-to-point interaction channel of a bottom-layer BDS, a point-to-point interaction channel in the network layer, or an IP based point-to-point direct interaction channel. The user may, through the content client, select a certain channel; or the operator may designate one channel for the user and set information related to the channel in the content client.

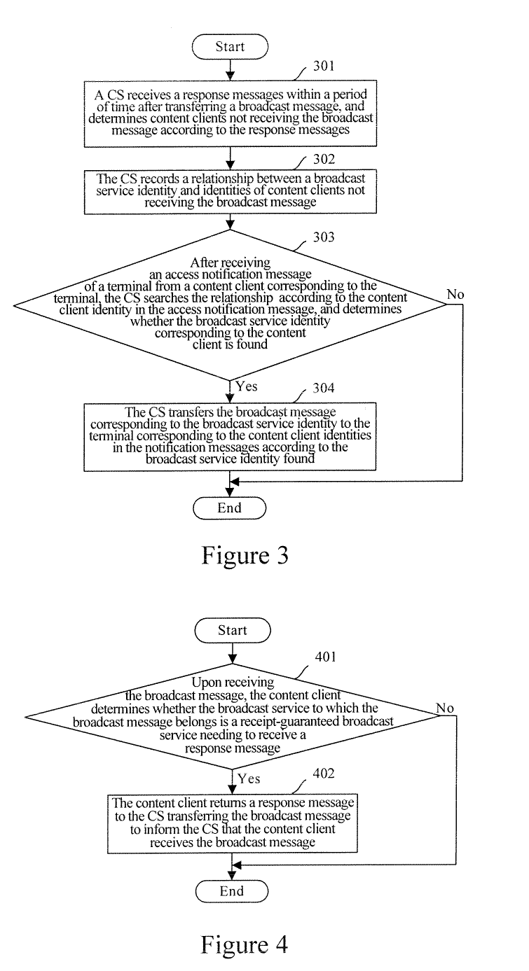

During the implementation of a broadcast service, a processing procedure of the CS is as shown in FIG. 3 and includes the processes as follows.

Process 301: the CS receives a response messages within a reception period of time after transferring a broadcast message, and determines content clients not receiving the broadcast message according to the response messages and a corresponding relationship between a broadcast service identity and a content client identity set in the response message.

In the process, through the broadcast message identity and the content client identity in the response message received by the CS, the CS may determine which of content clients returns the response message and determine the broadcast message corresponding to the response message. Then, the CS searches the corresponding relationship between the broadcast service identity and the content client identity according to the broadcast message identity to acquire all content clients customizing the receipt-guaranteed broadcast service corresponding to the broadcast message identity, and then determines which content clients do not return the response messages. The content clients which do not return the response messages are the ones not receiving the broadcast message.

Process 302: the CS records the corresponding relationship between the broadcast message identity and the identity of the content client not receiving the broadcast message.

In Process 301, it is assumed that, after transferring a broadcast message of a weather forecast service, the CS receives response messages of the broadcast message returned from B and D within a reception period of time set beforehand. Since the identities of content clients customizing the weather forecast service include A, B, C, and D, the CS may determine that A and C do not receive the broadcast message. In an example, if the identity of the broadcast service is 20050103 00012, the corresponding relationship recorded in the CS between the broadcast message identity and the identities of content clients not receiving the broadcast message is as shown in Table 2.

TABLE II

| Content client identity | Broadcast message identity |
|---|---|
| A | 20050103 00012 |
| C | 20050103 00012 |
| . . . | . . . |

Process 303: upon receiving an access notification message of the terminal from the content client, the CS searches the corresponding relationship recorded in the CS between the broadcast message identity and the identities of content clients not receiving the broadcast message according to the content client identity in the access notification message to acquire the broadcast message identity corresponding to the identities of content clients not receiving the broadcast message, and determines whether the broadcast message identity corresponding to the identities of content clients not receiving the broadcast message is found. If yes, perform Process 304; otherwise, terminate the procedure directly.

In the process, as an example, the access notification message may be transferred to the CS according to the CS identity set beforehand in the content client after the terminal accesses the network. In the example, the access notification message may include the content client identity. In the present embodiment of the invention, the content client may transfer the access notification message to one or more CSs. If there is only one CS corresponding to the receipt-guaranteed broadcast service customized by the user, only the CS identity needs to be set. If there are multiple CSs corresponding to the receipt-guaranteed broadcast service customized by the user, it is necessary to set identities of the multiple CSs.

As another example, the access notification message may be transferred to the CS corresponding to the CS identity by a Home Location Register (HLR) according to the CS identity set beforehand in the HLR after the HLR determines that the terminal corresponding to the content client accesses the network from an off-line state. In this example, it is needed to set beforehand, in the HLR and user data of the terminal corresponding to the content client, the identity of the CS needing to receive the access notification message from the terminal when the terminal accesses the network.

In some examples, the CS may still receive the access notification message from the content client after the content client receiving the broadcast message accesses the network. As a result, it is impossible to find the broadcast message identity corresponding to the content client identity in the access notification message, which may result in a system error. So if the CS determines that it is impossible to find the broadcast message identity corresponding to the content client identity, the current procedure is terminated.

Process 304: the CS, according to the broadcast message identity found, transfers the broadcast message corresponding to the broadcast message identity to the content client corresponding to the content client identity in the access notification message.

In the process, the CS may transfer to the content client a notification message asking the content client to fetch the broadcast message, the notification message includes an address for storing contents of the broadcast message which is not received by the user. Upon receiving the notification message, the content client acquires the contents of the broadcast message according to the address in the notification message.

The forgoing description illustrates an embodiment of the invention. According to another embodiment of the invention, the content client may also return a response message to the CS according to a receipt-guaranteed broadcast service customized. The present embodiment of the invention will be described hereinafier in detail.

In the present embodiment of the invention, it is needed to set beforehand in the content client a receipt-guaranteed broadcast service in which a response message needs to be returned.

When a user transfers a customization message for customizing a receipt-guaranteed broadcast service through the content client in the terminal, the content client automatically records the broadcast service in the customization message as a receipt-guaranteed broadcast service in which a response message needs to be returned. In addition, if the user customizes the receipt-guaranteed broadcast service through a network or a telecom business office, the CS transfers to the content client of the user a message after the user customizes the receipt-guaranteed broadcast service, the message includes information of the receipt-guaranteed broadcast service. Upon receiving the message, the content client sets the broadcast service as a receipt-guaranteed broadcast service in which a response message needs to be retained according to the information of the receipt-guaranteed broadcast service in the message.

During the implementation of a broadcast service, the processing procedure of the CS is the same as that of the above mentioned embodiment. The processing procedure of the content client is as shown in FIG. 4 and includes the following processes.

Process 401: upon receiving a broadcast message, the content client determines whether the broadcast service to which the broadcast message belongs is a receipt-guaranteed broadcast service in which a response message needs to be returned and which is set in the content client. If yes, perform Process 402; otherwise, terminate the procedure directly, i.e., do not return a response message.

Process 402: the content client returns a response message to the CS transferring the broadcast message to inform the CS that the broadcast message is received.

The forgoing description just describes specific embodiments of the invention and therefore the method of the invention can be modified appropriately during the detailed implementation, to meet the specific requirements of the specific cases. It is thereby understood that the specific embodiments according to the invention are just demonstrative, and are not for use in limiting the protection scope of the invention.

What is claimed is:

1. A method for implementing a mobile data broadcast service, comprising:
determining that a content client does not receive a broadcast message; and
transferring the broadcast message to the content client after leaning that a terminal corresponding to the content client accesses a network.

2. The method of claim 1, further comprising:
recording a relationship between an identity of the content client not receiving the broadcast message and an identity of the broadcast message;
wherein the process of transferring the broadcast message to the content client comprises:
transferring the broadcast message to the content client not receiving the broadcast message according to the relationship between the identity of the content client not receiving the broadcast message and the identity of the broadcast message.

3. The method of claim 1, wherein the process of learning that the terminal corresponding to the content client accesses the network comprises:
receiving an access notification message of the terminal from the content client.

4. The method of claim 3, further comprising:
recording a relationship between an identity of the content client not receiving the broadcast message and an identity of the broadcast message;
searching the relationship between the identity of the content client not receiving the broadcast message and the identity of the broadcast message according to the access notification message, and determining the broadcast message according to the relationship between the identity of the content client not receiving the broadcast message and the identity of the broadcast message.

5. The method of claim 1 wherein a Content Server (CS) identity is stored in a Home Location Register (HLR);
the process of learning that the terminal corresponding to the content client accesses the network comprises:
receiving an access notification message sent by the HLR according to the CS identity after the HLR determines that the terminal accesses the network.

6. The method of claim 1, wherein the process of learning that the terminal corresponding to the content client accesses the network comprises:
receiving an access notification message sent by the content client according to a CS identity stored in the content client after the terminal corresponding to the content client accesses the network.

7. The method of claim 1, further comprising:
storing a relationship between a receipt-guaranteed broadcast service and the content client;
acquiring the content client not receiving the broadcast message through searching the relationship between the receipt-guaranteed broadcast service and the content client according to the receipt-guaranteed broadcast service to which the broadcast message belongs.

8. The method of claim 1, further comprising:
returning, a response message to a CS upon receiving the broadcast message;
wherein the process of determining that the content client does not receive the broadcast message comprises:
determining that the content server does not receive the response message from the content client.

9. The method of claim 8, wherein the process of determining that the content client does not receive the broadcast message comprises:
determining that the response message returned by the content client is not received in a preset period of time.

10. The method of claim 8, wherein a receipt-guaranteed broadcast service customized by the terminal is set in the content client corresponding to the terminal;
the method further comprises:
determining that the broadcast service to which the broadcast message received belongs is the receipt-guaranteed broadcast service before returning the response message.

11. The method of claim 10, wherein the process of the receipt-guaranteed broadcast service being set in the content client comprises:
setting the broadcast service as the receipt-guaranteed broadcast service upon transferring a customization message for customizing the receipt-guaranteed broadcast service.

12. The method of claim 10, further comprising:
transferring a customization message to the content client corresponding to the terminal when the terminal customizes the receipt-guaranteed broadcast service.

13. A Content Server (CS) for implementing a mobile data broadcast service, comprising:
a first module, for determining that a content client does not receive a broadcast message after sending the broadcast message; and
a second module, for transferring the broadcast message to the content client according to the result of determining when a terminal corresponding to the content client accesses a network.

14. The CS of claim 13, further comprising:
a third module, for recording a relationship between an identity of the content client not receiving the broadcast message and an identity of the broadcast message, and providing the identity of the content client corresponding to the identity of the broadcast message for the second module according to the relationship.

15. The CS of claim 13, further comprising:
a fourth module, for storing a relationship between a receipt-guaranteed broadcast service and the content client;
wherein, the second module is further used for acquiring the content client to which the broadcast message belongs through searching the relationship between a receipt-guaranteed broadcast service and the content client.

16. A content client for implementing a mobile data broadcast service, comprising:
a first module, for recording a relationship between a receipt-guaranteed broadcast service and the content client;
a second module, for determining whether a broadcast service to which a broadcast message received belongs is the receipt-guaranteed broadcast service according to the relationship;
a third module, for outputting a response message if the second module determines that the broadcast service is the receipt-guaranteed broadcast service.
